(19) United States
(12) Patent Application Publication
(10) Pub. No.: US 2007/0016480 A1
(43) Pub. Date: Jan. 18, 2007

(54) HOME PAGE ADVERTISING METHOD

(75) Inventor: Kang-chun LEE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., SUWON-CITY (KR)

(21) Appl. No.: 11/534,566

(22) Filed: Sep. 22, 2006

Related U.S. Application Data
(62) Division of application No. 09/799,805, filed on Mar. 7, 2001.

(30) Foreign Application Priority Data
Apr. 10, 2000 (KR) 00-18668

(51) Int. Cl. G06Q 30/00

(52) U.S. Cl. 705/14

(57) ABSTRACT

A home page advertising method is provided. The home page advertising method for transmitting home page data, including advertisement information, from a server to a client computer, wherein the server computer and client computers are interconnected through a network, includes the step of transmitting home page data, including one or more program codes that perform a predetermined layer function for displaying home page main content information and advertisement information on a home page screen in a separate window, wherein the program codes are written using a predetermined object-oriented programming language for implementing a predetermined multi-platform application within an operating system of the client computer. The home page advertising method reduces the complexity of a home page screen due to the presence of advertisement screens, while still effectively attracting the user's attention.

### CROSS-REFERENCE

This is a divisional of application Ser. No. 09/799,805 filed Mar. 7, 2001. The entire disclosure of the prior application is hereby incorporated by reference.

### BACKGROUND OF THE INVENTION

1. Field of the Invention

The present invention relates to a home page advertising method, and more particularly, to a home page advertising method for transmitting home page data, including advertisement information, from a server computer to a client computer, wherein the server computer and the client computers are interconnected through a network. The present application is based on Korean Patent Application No. 2000-18668 filed on Apr. 10, 2000, which is incorporated herein by reference.

2. Description of the Related Art

Conventional home page advertising methods have generally been realized through banner ads. Banner ads use animated-graphics interchange format (GIF) files, and always appear on a screen of a user computer. FIGS. 1A-1C illustrate a conventional home page advertising method. Referring to FIGS. 1A-1C, advertisement information 102, 104, and 106, in banner form, are displayed on screens of home pages. However, the conventional home page advertising method has a problem in that the banner ads always appear on a screen of a home page, and the home page looks cluttered and complicated when there is a large number of advertisement content. Furthermore, if an advertisement screen occupies many portions of the entire home page, users are likely to avoid accessing the home page. Conversely, if the advertisement content takes up a very small amount of space, it is unlikely to attract the users attention.

To solve the above problems, another conventional home page advertising method involves constructing home page data so that a small advertisement screen can move along a screen by tracking a mouse cursor of the user. However, this home page advertising method suffers from problems in that a small-sized advertisement screen limits advertisement consent and tracking a moving mouse cursor may irritate the user.

### SUMMARY OF THE INVENTION

To solve the above problems, it is an objective of the present invention to provide a home page advertising method capable of attracting the attention of a user while not complicating the home page environment by an advertisement screen.

It is another objective of the invention to provide a computer-readable recording medium on which a program for performing the home page advertising method is stored Accordingly, to achieve the above objectives, the present invention provides a home page advertising method for transmitting home page data including advertisement information from a server computer to a client computer, wherein the server computer and the client computers are interconnected through a network. The home page advertising method includes the step of transmitting home page data, including one or more program codes that perform a predetermined layer function for displaying home page main content information and advertisement information on a home page screen in a separate window, from the server computer to the network, wherein the program codes are written using a predetermined object-oriented programming language for implementing a predetermined multi-platform application within an operating system of the client computer.

The home page data further includes one or more program codes that perform a predetermined onload event function for initializing a screen so that the home page main content information and the advertisement information can be selectively displayed depending on exchanges of a timer value within an external operating system.

The present invention also provides a home page advertising method for transmitting home page data, including advertisement information, from a server computer to a client computer, wherein the server computer and the client computers are interconnected through a network. The home page advertising method includes the steps of transmitting home page data, including one or more program codes that perform a predetermined layer function for hiding advertisement information with respect to home page main content information, to a network, wherein the program codes are written using a predetermined object-oriented programming language for implementing a predetermined multi-platform application within an operating system of the client computer.

The home page data further includes one or more program codes that perform a predetermined ActiveX function for selectively displaying the advertisement information on a home page screen depending on exchanges of a timer value within an external operating system, and for moving a display position of the advertisement information. The display position is set in such a way as to arbitrarily move the display position or to move the display position to a position designated by a value of a desired display position after storing the position value.

The present invention also provides a computer-readable recording medium for storing home page data including advertisement information transmitted from a server computer to a client computer, wherein the server computer and the client computers are interconnected through a network. The computer-readable recording medium includes one or more program codes that perform a predetermined layer function for displaying home page main content information and advertisement information on a home page screen in a separate window, wherein the program codes are written using a predetermined object-oriented programming language for implementing a predetermined multi-platform application within an operating system of the client computer.

The present invention also provides a computer-readable recording medium for storing home page data, including advertisement information, transmitted from a server computer to a client computer, wherein the server computer and the client computers are interconnected through a network. The computer-readable recording medium includes one or more program codes that perform a predetermined layer function for hiding advertisement information with respect to home page main content information, wherein the program codes are written using a predetermined object-oriented programming language for implementing a predetermined multi-platform application within an operating system of the client computer.

### BRIEF DESCRIPTION OF THE DRAWINGS

The above objective(s) and advantages of the present invention will become more apparent by describing in detail a preferred embodiment thereof with reference to the attached drawings in which:

FIGS. 1A-1C show examples for explaining a conventional home page advertising method;

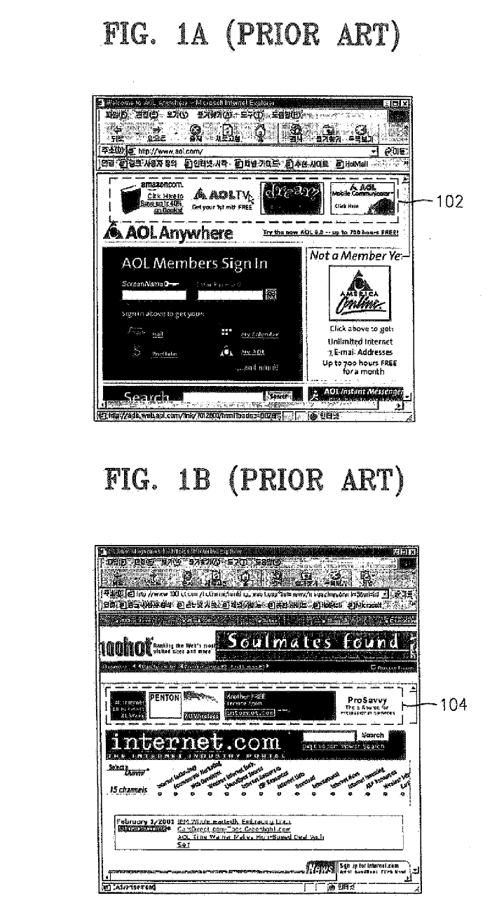

FIG. 2 shows the structure of home page data used in a home page advertising method according to the first embodiment of the present invention,

FIG. 3 shows a process of transmitting home page data having the structure shown in FIG. 2 from a server computer to a client computer;

FIG. 4 is a block diagram showing a process of executing the home page data transmitted using the home page advertising method according to the first embodiment of the invention shown in FIG. 2;

FIGS. 5A-5C are examples of screens for explaining the operation of displaying the home page data transmitted using the home page advertising method according to the first embodiment of the invention shown in FIG. 2 on a screen of the client computer;

FIG. 6 shows the structure of home page data used in a home page advertising method according to a second embodiment of the invention;

FIG. 7 is a block diagram showing a process of executing the home page data according to the second embodiment of the invention shown in FIG. 6; and

FIGS. 8A-8C are examples of screens for explaining the operation of displaying the home page data transmitted using the home page advertising method according to the second embodiment of the invention shown in FIG. 6 on the screen of a client computer.

### DETAILED DESCRIPTION OF THE INVENTION

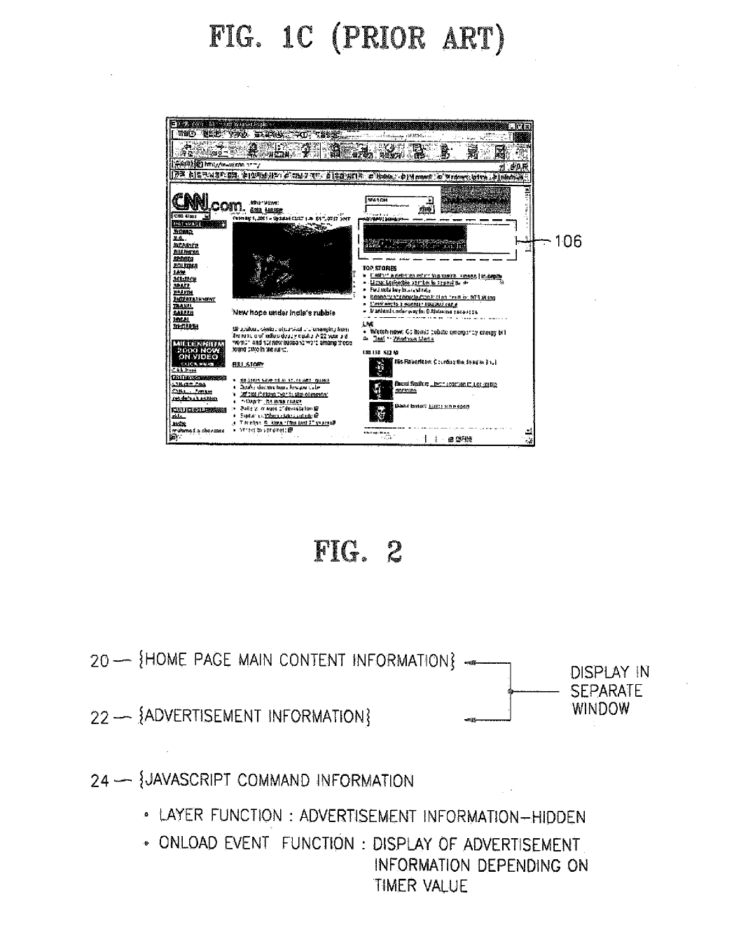

Referring to FIG. 2, in a home page advertising method according to a first embodiment of the invention, home page data includes home page main content information 20, advertisement information 22, and JavaScript command information 24. In the embodiment, the JavaScript command information 24 includes one or more program codes that perform a predetermined layer function for displaying the home page main content information 20 and the advertisement data in a separate window on the screen of a client computer. Furthermore, the JavaScript command information 24 contains program code that performs a predetermined onload event function for initializing a screen so that the home page main content information 20 and the advertisement information 22 can be displayed selectively depending on exchanges of a timer value within an external operating system. In the embodiment, the JavaScript command information 24 is composed of an object-oriented programming language for implementing a predetermined multi-platform application within the operating system of a client computer, and in particular, composed of a programming language developed by Sun Microsystems (Registered trademark: Sun Microsystems).

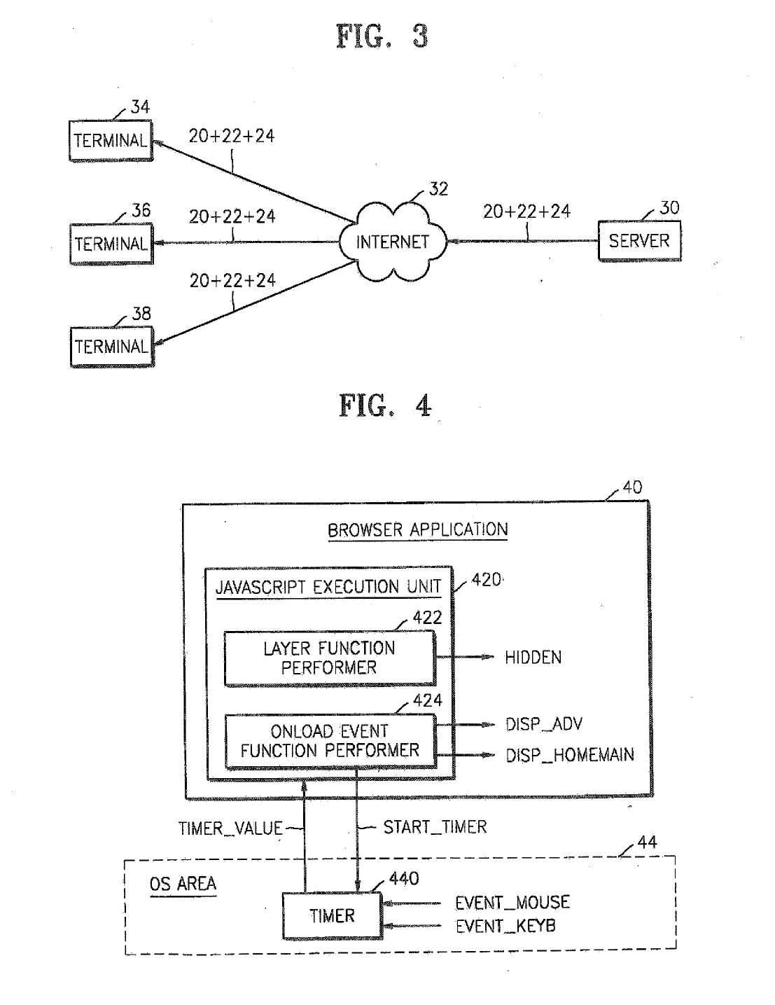

Referring to FIG. 3, which shows a process of transmitting tile home page data having the structure shown in FIG. 2 from a server computer to a client computer, home page data 20+22+24 having the structure shown in FIG. 2 is transmitted from a server computer 30 to the Internet 32, where “+” means that each program code is included in the home page data. Terminals 34, 36 and 38 which access a home page provided by a server computer through the Internet 32 receives home page data according to a hyper-text transfer protocol (HTTP).

The terminals 34, 36, and 38, i.e., client computers, receive the program codes in an object-oriented programming language contained in the home page data being implemented on the operating system of a client computer by a JavaScript program installed within the browser application.

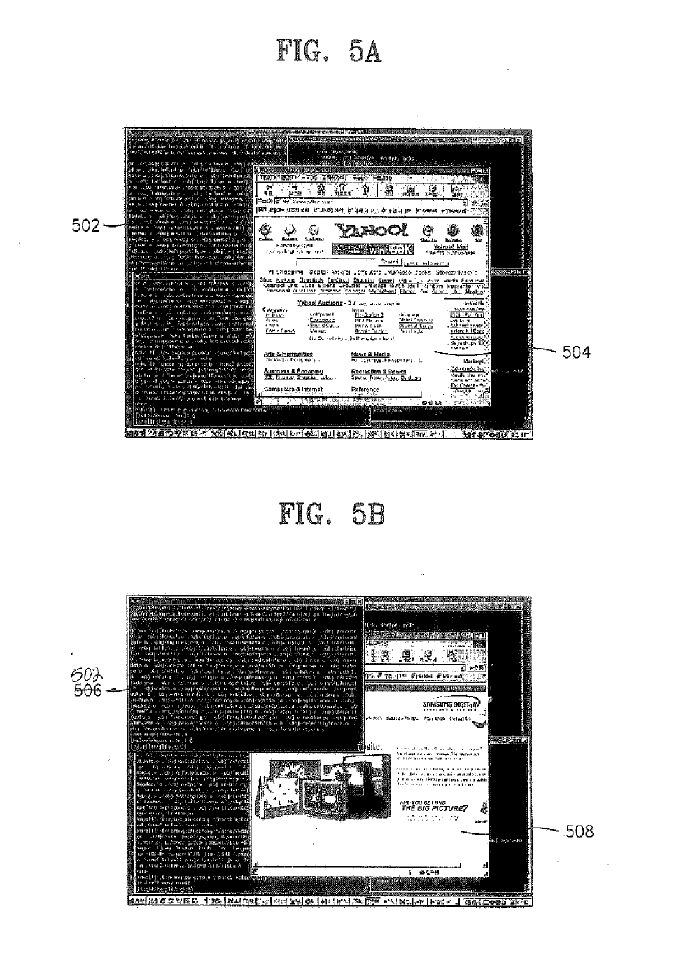

FIG. 4 shows a process of executing home page data transmitted using the home page advertising method according to the first embodiment of the invention shown in FIG. 2 on a client computer. Referring to FIG. 4, a JavaScript program installed within a browser application 40 may be referred to as a JavaScript execution unit 420 for executing JavaScript. Further, the JavaScript execution unit 420 includes a layer function performer 422 and an onload event function performer 424. The layer function performer 422 outputs a hidden control signal when home page data is loaded using a layer function so that only the home page main content information may be displayed on a screen with the advertisement information 22 hidden.

If all home page data is input to the browser application 40, the onload event function performer 424 outputs a timer starting signal start_timer to initiate a timer 440 within an operating system (OS) area 44. The timer 440 increases a timer value timer_value in response to the timer starting signal start timer. If the input timer value timer_value reaches a predetermined critical value, the onload event function performer 424 outputs an advertisement information display signal disp_adv in order to display an advertisement screen which has been set to “hidden”. The browser application 40 displays the advertisement information 22 appearing in a separate window on a screen in response to the advertisement information display signal disp_adv.

Meanwhile, if the user clicks a mouse button and presses a key, the OS area 44 generates a mouse event signal event_mouse and a keyboard event signal event_keyb, respectively, which are interrupt signals indicating that user actions have occurred. If the mouse event signal event_mouse and the keyboard event signal event_keyb are input to the timer 440, the timer 440 is then reset. If the timer is reset, the onload event function performer 424 outputs a home page main content information display signal disp_homemain. The browser application 40 displays the home page main content information 20 appearing in a separate window on a screen in response to the home page main content information display signal disp_homemain.

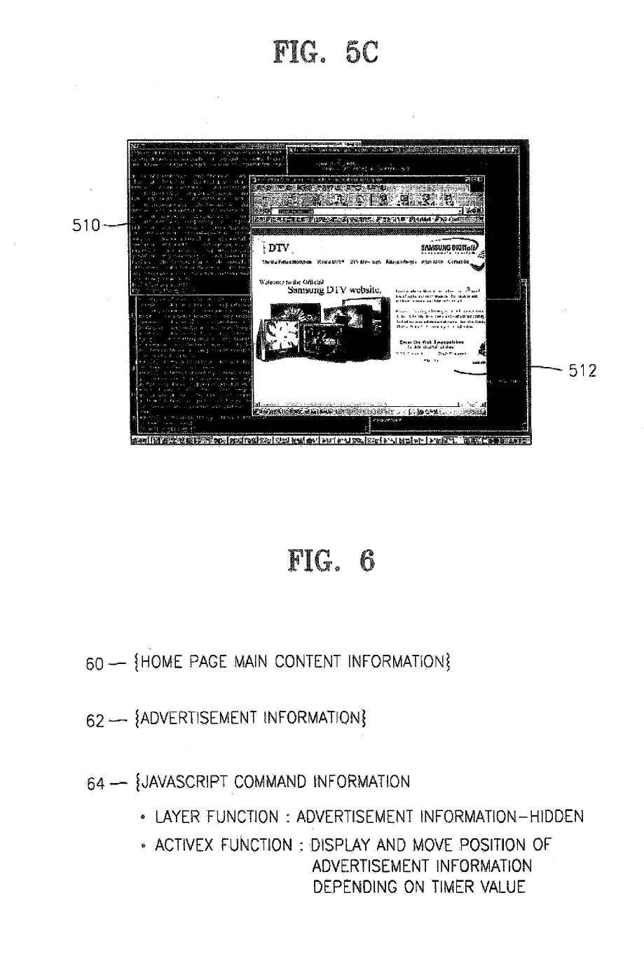

FIGS. 5A-5C are examples of screens for explaining an operation of displaying home page data on a screen, the home page data being transmitted using the home page advertising method according to the first embodiment of the invention shown in FIG. 2. If the user clicks a mouse button on a certain job window 502, a home page screen window 504 in FIG. 5A loses focus. In this case, a timer value timer_value output from the timer 440 increases. Alternatively, if the user does not click on a mouse button or press a key on the home page screen window 504 for a predetermined period of time, the timer value timer_value output from the timer 440 increases. Then, if the timer value time_value reaches a predetermined value, a hidden advertisement screen window 508 behind the home page screen window 504 in FIG. 5A is displayed on top of a home page screen window 504 in FIG. 5A, as shown in FIG. 5B, in which case a timer value timer_value output from the timer 440 does not increase further. Also, it is preferred that the URL of the previous home page screen window 504 remains in the web page corresponding to the advertisement screen window 508.

Meanwhile, if the advertisement screen window 508 gains focus, when the user clicks a mouse button or presses a key on the advertisement screen window 508, the advertisement screen window 512 appears over the job window 510 as shown in FIG. 5C, and then the timer 440 is reset to increase the timer value timer_value. However, the user can return to the previous home page by entering the remained URL of the previous home page screen window 504.

In the home page advertising method described above, when home page data is initially loaded, an advertisement screen window is hidden. Conversely, when the user does not click on a mouse button or does not press a key for a predetermined period of time or the home page window is out of focus, the advertisement screen window is displayed. Accordingly, the home page advertising method prevents a home page screen from being too complex due to the presence of an advertisement screen, while displaying a user-oriented advertisement, by displaying a hidden advertisement screen only when no user actions occur, such as pressing a key or clicking a mouse button. Furthermore, this method allows the user's attention to be effectively attracted.

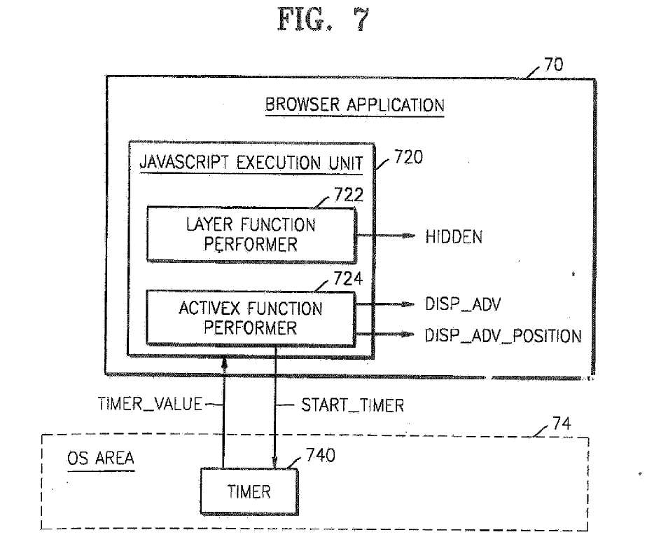

FIG. 6 shows a home page data structure used in a home page advertising method according to a second embodiment of the invention. Referring to FIG. 6, home page data contains home page main content information 60, advertisement information 62, and JavaScript command information 64. In the second embodiment, the JavaScript command information 64 includes program code for performing a predetermined layer function in which the advertisement information is hidden with respect to the home page main content information 60. Further, the JavaScript command information 64 contains program code which performs a predetermined ActiveX function for selectively displaying the advertisement information 62 on a home page screen depending on exchanges of a timer value within an external operating system, and for moving an advertisement information display position. The JavaScript command information 64 is in an object-oriented programming language for implementing a predetermined multi-platform application within an operating system of a client computer. In 10 particular, it is in the form of a programming language developed by Sun Microsystems as described in the first embodiment.

As described with reference to FIG. 3, home page data having the structure shown in FIG. 6 is transferred from a server computer 30 to the Internet 32. Terminals 34, 36, 38 that access a home page provided by the server computer 30 through the Internet 32 receive the home page data according to the HTTP protocol. The program codes included in the home page data, which are written using an object-oriented programming language are executed as a separate multi-platform application by a Java program installed within the browser application of the terminals 34, 36, and 38, or client computers.

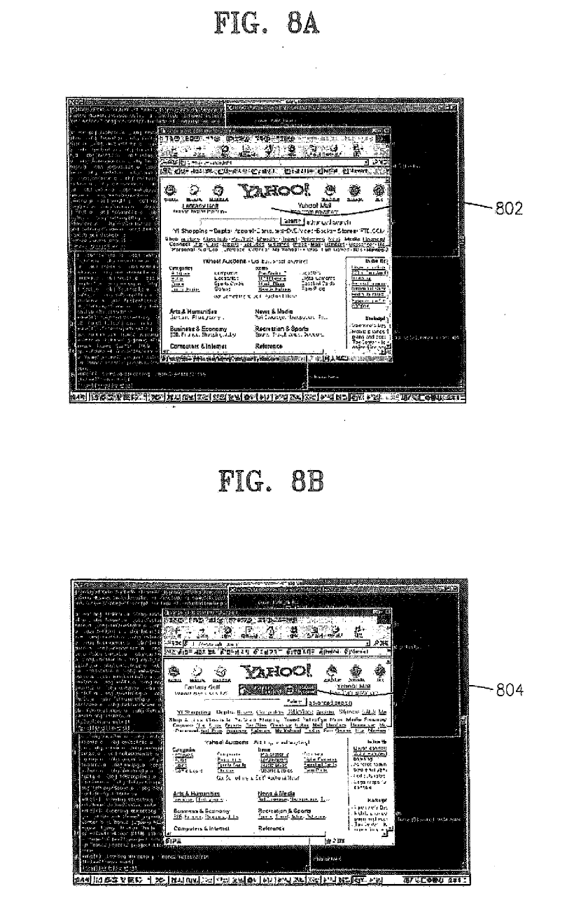

FIG. 7 shows a process of executing the home page data on a client computer, the home page data being transmitted using the home page advertising method according to the second embodiment of FIG. 6. Referring to FIG. 7, a Java program installed within a browser application 70 may be referred to as a JavaScript execution unit 720. Further, the JavaScript execution unit 720 includes a layer function performer 722 and an ActiveX function performer 724.

The layer function performer 722 uses the layer function of JavaScript in which the advertisement information 62 is hidden with respect to the home page main content information 60. Thus, it outputs a hidden control signal if all home page data is input to the browser application 70, so that only the home page main content information 60 is displayed on a screen with the advertisement information 62 hidden.

If all the home page data is input to the browser application 70, the ActiveX function performer 724 outputs a timer starting signal start_timer to initiate a timer 740 within an operating system (OS) area 74. The timer 740 increases a timer value timer_value in response to the timer starting signal start_timer. Furthermore, the JavaScript command information 64 contains, within the home page data, program code for performing an ActiveX function so that the advertisement data 62 may be selectively displayed on a home page screen depending on exchanges of the timer value timer_value within an external operation system, and so that the display position of the advertisement information 62 may be moved. Thus, the ActiveX function performer 724 executes the program code. As a result, if the input timer value timer-value reaches a predetermined first critical value, the ActiveX function performer 724 outputs an advertisement information display signal disp_adv in order to display an advertisement screen, which has been set to “hidden”. The browser application 70 displays the advertisement information 62 on a screen in response to the advertisement screen display signal disp adv. Furthermore, if the timer value timer_value increases with the passing of time to reach a predetermined second critical value, the layer function performer 722 outputs a hidden control signal so that the advertisement screen may be set to “hidden”.

Accordingly, the advertisement information 62 is selectively displayed within a home page screen according to a time value. Furthermore, the advertisement information 62 may have its display position moved. The display position may be set in such a way as to move it to an arbitrary position of a home page or to a position designated by a stored value.

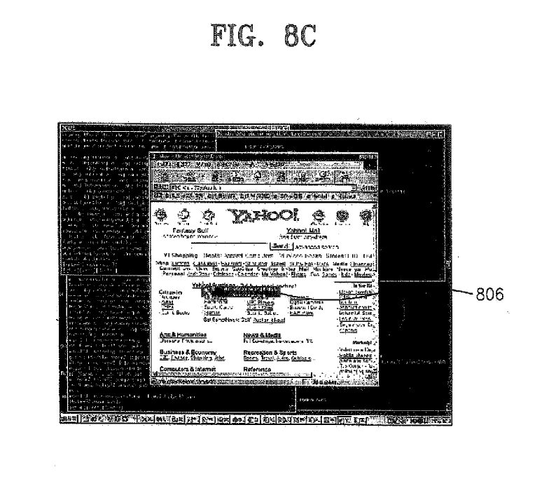

FIGS. 8A-8C are examples of screens for explaining an operation of displaying home page data on a screen, the home page data being transmitted 15 using the home page advertising method according to the second embodiment of the invention shown in FIG. 6. Referring to FIGS. 8A-8C, according to the home page advertising method described above, nothing appears in an advertisement screen region 802 for a predetermined period of time after all home page data is loaded. However, with the passing of a predetermined period of time, advertisement information 804 appears. Again, after a predetermined period of time lapses, the advertisement information 804 disappears from the home page. Furthermore, if an advertisement position is set to be moved, the advertisement information 806 is moved to either predetermined positions or arbitrary positions on the home page.

According to the home page advertising method, when home page data is loaded at an initial stage, an advertisement screen window is hidden. After a predetermined period of time lapses, the advertisement information 804 appears in the form of a banner ad and disappears at regular time intervals.

Furthermore, the position of advertisement information 804 may be moved on a home page screen according to a time while displaying it on a screen. Also, clicking on the advertisement information 804 displayed in the form of a banner ad enables the user to go to an appropriate advertisement site. As a consequence, the home page advertising method prevents a home page screen from being too complex due to advertisement screens, while still attracting the user's attention effectively.

Furthermore, the home page advertising method according to the invention can be written as a program executed on a personal or server computer. The program codes and code segments constructing a program can be easily inferred by computer programmers in the industry. Furthermore, the program can be stored in a computer-readable recording medium. The recording medium includes a magnetic recording medium, an optical recording medium, and a radio medium.

What is claimed is:

1. A home page advertising method for transmitting home page data, including advertisement information, from a server to a client computer, wherein the server computer and client computers are interconnected through a network, the home page advertising method comprising the step of transmitting home page data, including one or more program codes that perform a predetermined layer function for hiding advertisement information with respect to home page main content information, to the network.

2. The home page advertising method of claim 1, wherein the program codes are written using a predetermined object-oriented programming language for implementing a predetermined multi-platform application within an operating system of the client computer.

3. The home page advertising method of claim 1, wherein the home page data further includes one or more program codes that perform a predetermined ActiveX function for selectively displaying the advertisement information on a home page screen depending on exchanges of a timer value within an external operating system, and for moving a display position of the advertisement information. The home page advertising method of claim 5, wherein the home page data further includes one or more program codes that perform a predetermined ActiveX function for selectively displaying the advertisement information on a home page screen depending on a focus status of a current web page window, and for moving the display position of the advertisement information.

4. The home page advertising method of claim 3, wherein the display position is set in such a way as to arbitrarily move the display position or to move the display position to a position designated by a stored value.

5. The home page advertising method of claim 1, wherein the home page data further includes one or more program codes that perform a predetermined ActiveX function for selectively displaying the advertisement information on a home page screen depending on a focus status of a current web page window, and for moving the display position of the advertisement information, and
wherein the display position is set in such a way as to arbitrarily move the display position or to move the display position to a position designated by a stored value.

6. A computer-readable recording medium for storing home page data, including advertisement information, transmitted from a server computer to a client computer, wherein the server computer and client computers are interconnected through a network, the recording medium comprising one or more program codes that perform a predetermined layer function for hiding advertisement information with respect to home page main content information.

7. The recording medium of claim 6, wherein the program codes are written using a predetermined object oriented programming language for implementing a predetermined multi-platform application within an operating system of the client computer.

8. The recording medium of claim 6, wherein the home page data further includes one or more program codes that perform a predetermined ActiveX function for selectively displaying advertisement information depending on exchanges of a timer value within an external operating system, and for moving a display position of the advertisement information.

9. The recording medium of claim 8, wherein the display position is set in such a way as to arbitrarily move the display position or to move the display position to a position designated by a stored value.

10. The recording medium of claim 6, wherein the home page data further includes one or more program codes that perform a predetermined ActiveX function for selectively displaying advertisement information depending on a focus status of a current web page window, and for moving a display position of the advertisement information, and
wherein the display position is set in such a way as to arbitrarily move the display position or to move the display position to a position designated by a stored value.
